(19) United States
(12) Patent Application Publication
(10) Pub. No.: US 2015/0031783 A1
(43) Pub. Date: Jan. 29, 2015

(54) LIQUID MINERAL COATING

(71) Applicant: Tintas Hidracor S/A, Maracanau (BR)

(72) Inventor: Vasnir Aquino Barbosa, Fortaleza (BR)

(21) Appl. No.: 14/072,544

(22) Filed: Nov. 5, 2013

(30) Foreign Application Priority Data
Jul. 24, 2013 (BR) BR 1020130189286

(51) Int. Cl. C09D 5/14

(52) U.S. Cl. CPC C09D 5/14
USPC 523/122

(57) ABSTRACT

A liquid mineral coating is disclosed which formulation includes calcium hydroxide (Ca(HO)2) and magnesium hydroxide Mg(OH2) associated with an organic polymer, allowing control of fungal growth and coating blistering or peeling due to rising moisture in the substrate, keeping the environment stable, without the need of adding stabilizers, such as D-Sorbitol, commonly used in conventional mineral coatings.

### RELATED APPLICATION INFORMATION

This patent claims priority under 35 U.S.C. §119 to the following prior-filed copending non-provisional foreign patent applications: Application Number: BR 1020130189286, filed Jul. 24, 2013.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF THE INVENTION

The present application pertains to liquid mineral coatings that provide protective and/or decorative coatings for walls and other surfaces.

### BACKGROUND OF THE INVENTION

Liquid mineral coatings and other coatings are commonly used for indoor and outdoor applications in buildings, aiming at providing protective and/or decorative coatings for walls and other surfaces. These compositions generally comprise water and a polymeric binder selected from acrylic, vinyl, urethane polymers, among others. Optionally, these compositions may include one or more pigments in order to obtain colors.

The liquid mineral coating may be used as an alternative to latex paint, keeping a more natural aspect of the substrate, without the lamination aspect that usually occurs with conventional latex.

The application of organic coatings on the surface of buildings promotes sealing, avoiding evaporation of the moisture from the wall, then causing blistering and coating peeling.

Thereby, the object of this invention consists of a liquid mineral coating which formulation includes the addition of calcium hydroxide (Ca(HO)₂) and magnesium hydroxide (Mg) to an organic polymer to avoid fungal growth and coating blistering or peeling, eliminating the need of stabilizers.

### SUMMARY OF THE INVENTION

This invention provides a liquid mineral coating that protects surfaces from fungal proliferation.

The invention provides a liquid mineral coating that allows moisture evaporation, avoiding blistering and peeling.

The invention provides a liquid mineral coating that may be applied indoors without the risk of intoxication.

This invention discloses a liquid mineral coating. It comprises, more specifically, a liquid mineral coating which formulation includes calcium hydroxide (Ca(HO)₂) and magnesium hydroxide Mg(OH₂) associated with an organic polymer, allowing control of fungal growth and coating blistering or peeling due to rising moisture in the substrate, keeping the environment stable, without the need of adding stabilizers, such as D-Sorbitol, commonly used in conventional mineral coatings.

One preferred embodiment of the liquid mineral coating according to the present application includes 15.0% to 85.0% of a mineral load, 5.0% to 80.0% of calcium hydroxide and magnesium hydroxide, 0.5% to 15% of an organic or inorganic binder, and up to 15.0% of water. The organic binder may be selected from:
a. terpolymers derived from vinyl ester of versatic acid with vinyl monomers and others such as:
   i. alkyl esters, carboxylic acids including:
      1. acrylates and methacrylates, such as ethyl acrylate, 2-etilhexil acrylates, methyl methacrylate, butyl acrylates and similar acrylates,
b. acrylic copolymers derived from the monomers above,
c. acrylic monomers and other monomers such as:
   i. butadiene, styrene and vinyl toluene,
d. vinyl halogenides such as:
   i. vinyl chloride, vinyl bromide and vinylidene chloride,
e. unsaturated nitriles, such as acrylonitrile and methacrylate,
f. unsaturated amides, such as acrylamide and its modifications,
g. carboxylic acids such as:
   i. acrylic acid, methacrylic acid and maleic or anhydride acid, fumarico acid, and
h. other polymerizable monomers, such as Hydroxyethyl Acrylate and methacrylates.

### DESCRIPTION OF THE PREFERRED EMBODIMENTS

One preferred embodiment of the liquid mineral coating comprises 5.0% to 80.0% of calcium hydroxide and magnesium hydroxide, 0.5% to 15% of a binder, 15.0% to 85.0% of a mineral load, and up to 15.0% of water.

The liquid mineral coating desirably also has an organic or inorganic binder which, after being applied onto the substrate and dried, forms a continuous and adhering film. The organic binder is preferably selected from terpolymers derived from vinyl ester of versatic acid with vinyl monomers and others, such as alkyl esters, carboxylic acids, including acrylates and methacrylates, such as ethyl acrylate, 2-etilhexil acrylates, methyl methacrylate, butyl acrylates and the similar, acrylic copolymers derived from the monomers above, from acrylic monomers and other monomers, such as butadiene, styrene and vinyl toluene, vinyl halogenides, such as vinyl chloride, vinyl bromide and vinylidene chloride, unsaturated nitriles, such as acrylonitrile and methacrylate, unsaturated amides, such as acrylamide and its modifications, carboxylic acids, such as acrylic acid, methacrylic acid and maleic or anhydride acid, fumarico acid, and other polymerizable monomers, such as Hydroxyethyl Acrylate and methacrylates.

Optionally, the mineral load may include calcium carbonate, clay, aluminum or magnesium silicates, metasilicates, barium sulfate, zinc oxide or sulfides or others in a proportion of up to 40%.

Optionally, the formulation has 0.1% to 3.0% of urethane, cellulosic, acrylic or mineral thickeners.

Optionally, the liquid mineral coating has organic or inorganic pigments, alone or combined.

Optionally, the liquid mineral coating comprises the addition of coalescing, dispersing, antifoaming agents, adhesion promoters, hydrofugant agents, among others.

The liquid mineral coatings described herein are potentially useful for application on alkaline substrates, such as plaster and concrete, but may also be applied to several other substrates, such as natural wood, industrialized wood, plaster, fiber cement, ceramic, metals, synthetic substrates, asphalt, cellulosic substrates.

The liquid mineral coating may be applied to the surface using conventional methods and tools, such as roller, paintbrush, stencil brush, spray painting, among others.

It is claimed:

1. A liquid mineral coating comprising 15.0% to 85.0% of a mineral load, 5.0% to 80.0% of calcium hydroxide and magnesium hydroxide, 0.5% to 15% of an organic or inorganic binder, and up to 15.0% of water.

2. A liquid mineral coating according to claim 1, wherein the organic binder comprises a terpolymer derived from vinyl ester of versatic acid with vinyl monomers.

3. A liquid mineral coating according to claim 2, further including an alkyl ester.

4. A liquid mineral coating according to claim 2, further including a carboxylic acid.

5. A liquid mineral coating according to claim 4, wherein the carboxylic acid is selected from the group consisting of:
a. Acrylates,
b. Methacrylates,
c. ethyl acrylates,
d. 2-etilhexil acrylates,
e. methyl methacrylates, and
f. butyl acrylates.

6. A liquid mineral coating according to claim 1, wherein the organic binder comprises acrylic copolymers.

7. A liquid mineral coating according to claim 1, wherein the organic binder comprises acrylic monomers and other monomers.

8. A liquid mineral coating according to claim 1, wherein the other monomers are selected from the group consisting of:
a. butadiene,
b. styrene, and
c. vinyl toluene.

9. A liquid mineral coating according to claim 1, wherein the organic binder comprises vinyl halogenides.

10. A liquid mineral coating according to claim 9, wherein the vinyl halogenides are selected from the group consisting of:
a. vinyl chloride,
b. vinyl bromide, and
c. vinylidene chloride.

11. A liquid mineral coating according to claim 1, wherein the organic binder comprises unsaturated nitriles.

12. A liquid mineral coating according to claim 11, wherein the unsaturated nitriles are selected from the group consisting of:
a. acrylonitrile, and
b. methacrylate.

13. A liquid mineral coating according to claim 1, wherein the organic binder comprises unsaturated amides.

14. A liquid mineral coating according to claim 13, wherein the unsaturated amides comprise acrylamide and its modifications.

15. A liquid mineral coating according to claim 1, wherein the organic binder comprises carboxylic acids.

16. A liquid mineral coating according to claim 11, wherein the carboxylic acids are selected from the group consisting of:
a. acrylic acid,
b. methacrylic acid and maleic or anhydride acid,
c. fumarico acid, and
d. Hydroxyethyl Acrylate and methacrylates.

17. A liquid mineral coating according to claim 1, wherein the mineral load includes calcium carbonate, clay, aluminum or magnesium silicates, metasilicates, barium sulfate, zinc oxide or sulfides in a proportion of up to 40%.

18. A liquid mineral coating according to claim 1, further including 0.1% to 3.0% of urethane, cellulosic, acrylic or mineral thickeners.
